(19) United States
(12) Patent Application Publication
(10) Pub. No.: US 2018/0232801 A1
(43) Pub. Date: Aug. 16, 2018

(54) SYSTEM AND METHOD FOR USAGE BASED RENTAL (UBR) OF INDUSTRIAL AND ENGINEERING APPLICATIONS

(71) Applicant: Siemens Energy, Inc., Orlando, FL (US)

(72) Inventors: Vivek Sud, Houston, TX (US); David Eifert, Houston, TX (US); Syed Hussain, Houston, TX (US)

(21) Appl. No.: 15/897,806

(22) Filed: Feb. 15, 2018

Related U.S. Application Data
(60) Provisional application No. 62/459,783, filed on Feb. 16, 2017.
(60) Provisional application No. 62/466,545, filed on Mar. 3, 2017.

(51) Int. Cl. G06Q 30/06

(52) U.S. Cl. CPC G06Q 30/0645

(57) ABSTRACT

A method for usage based rental (UBR) of an industrial or engineering application includes providing an application with instructions executable on a computer system comprising a processor; providing multiple usage based rental (UBR) options for the application, each usage based rental (UBR) option comprising an intermitted usage to fixed and continuous time duration ratio R between 0 (zero) and 1 (one); and selecting a usage based rental (UBR) option from the multiple usage based rental (UBR) options, wherein the application is operable according to the selected ratio R governing the usage based rental (UBR) option. Further, a usage based rental (UBR) management system is disclosed.

### CROSS REFERENCE TO RELATED APPLICATIONS

This application claims benefit of U.S. provisional application No. 62/459,783 filed Feb. 16, 2017, and U.S. provisional application No. 62/466,545 filed Mar. 3, 2017, in the United States Patent and Trademark Office, the contents of which are herein incorporated by reference in their entirety.

### BACKGROUND

### 1. Field

Aspects of the present disclosure relate to a method and a system for usage based rental (UBR) of industrial and engineering applications. Industrial and engineering applications as used herein include many different types of tools, programs and applications such as for example safety systems for overpressure protection, plant piping and equipment corrosion management, oil and gas facilities design and simulation, project planning tools for developing technical definitions and solutions, project management tools and programs for planning, organizing and managing resource tools and developing resource estimates, and product lifecycle management applications.

### 2. Description of the Related Art

Many different industrial and engineering applications are available today and can be used for project planning and management, for example for planning and managing industrial projects such as power plants or oil and/or gas facilities etc. Typically, a user demand for such an application is dependent on an activity level within a specific and overall time duration when process safety, conceptual engineering and feasibility analysis studies are carried out. The activity level is intermittent and fluctuates during the specific time duration due to various factors such as readiness of input data to the program, interdependencies with associated activities and/or periods of compressed schedules for specific tasks. As a result, there are periods of high usage demand and low or even no usage demand and these can occur at any time in the overall time duration of the project(s) or studies. Currently, the user or customer does not have the option to tailor the usage of application(s) on an intermittent basis according to the activity level for specific time durations of the project(s) and/or engineering/process safety study and pay for the application(s) when they are used and not have to pay when the application(s) are not used.

### SUMMARY

A first aspect of the present disclosure provides a method for providing usage based rental (UBR) of an industrial or engineering application comprising: providing an application comprising instructions executable on a computer system comprising at least one processor; providing a plurality of usage based rental (UBR) options for the application, each usage based rental (UBR) option comprising an intermittent usage to a fixed and continuous time duration ratio R between 0 (zero) and 1 (one); and selecting a usage based rental (UBR) option from the plurality of usage based rental (UBR) options, wherein the application is operable according to the selected ratio R governing the usage based rental (UBR) option.

A second aspect of the present disclosure provides a usage based rental (UBR) management system comprising: an application comprising instructions executable on a computer system comprising at least one processor; a plurality of usage based rental (UBR) options for the application, each usage based rental (UBR) option comprising an intermittent usage to a fixed and continuous time duration ratio R, wherein the intermittent usage to fixed and continuous time duration ratio R comprises a total term and an intermittent permitted usage in term; and a permitted usage counter for monitoring the intermittent permitted usage in term.

A third aspect of the present disclosures provides a computer system comprising at least one processor and a UBR management system as described herein.

### BRIEF DESCRIPTION OF THE DRAWINGS

FIG. 1 illustrates a graphical representation of a usage based rental (UBR) management system for an industrial or engineering application in accordance with an exemplary embodiment of the present disclosure.

FIG. 2 illustrates a flow chart of a method for providing usage based rental (UBR) of an industrial or engineering application in accordance with an exemplary embodiment of the present disclosure.

FIG. 3 illustrates a block diagram of an example of a computer system capable of implementing the method and system according to embodiments of the present disclosure.

### DETAILED DESCRIPTION

To facilitate an understanding of embodiments, principles, and features of the present disclosure, they are explained hereinafter with reference to implementation in illustrative embodiments. In particular, they are described in the context of being system and method for providing usage based rental (UBR) of industrial and engineering applications. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

The term “usage based rental” will be referred to as UBR in the following detailed description in connection with the figures.

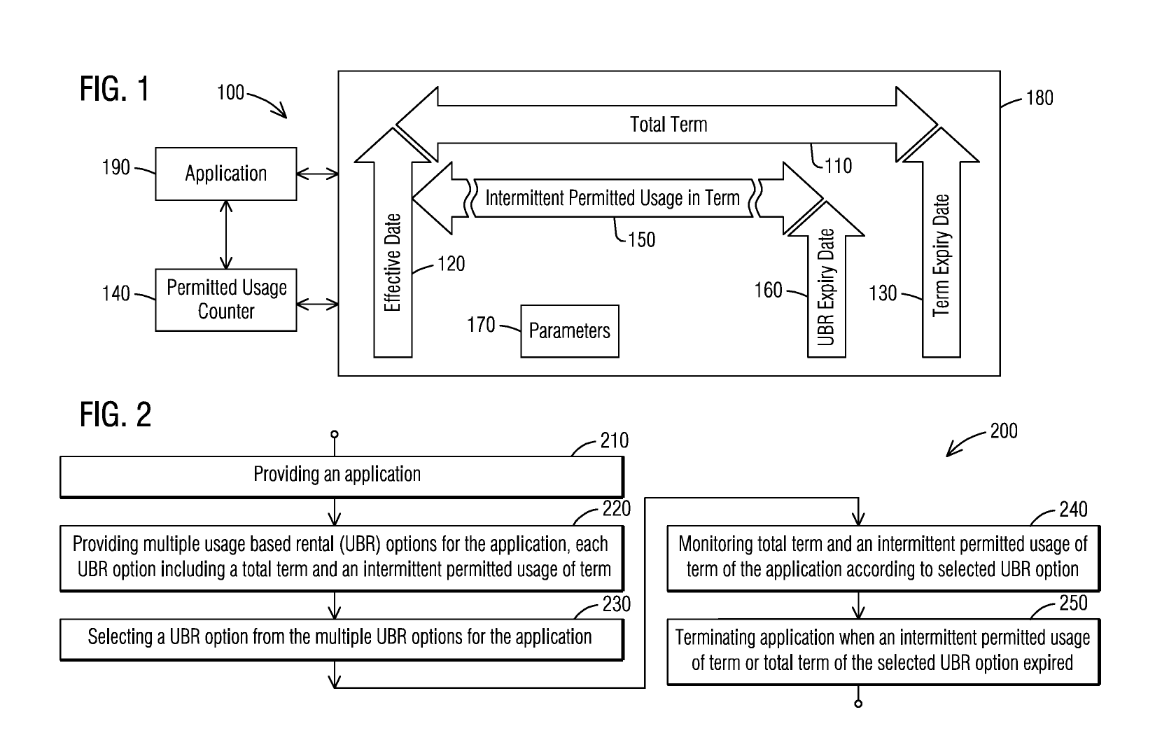

FIG. 1 illustrates a graphical representation of a UBR management system 100 in connection with an industrial or engineering application 190 in accordance with an exemplary embodiment of the present disclosure. The UBR management system 100 is herein also referred to as “UBR system”, “usage based subscription (UBS) system”, or “management system”.

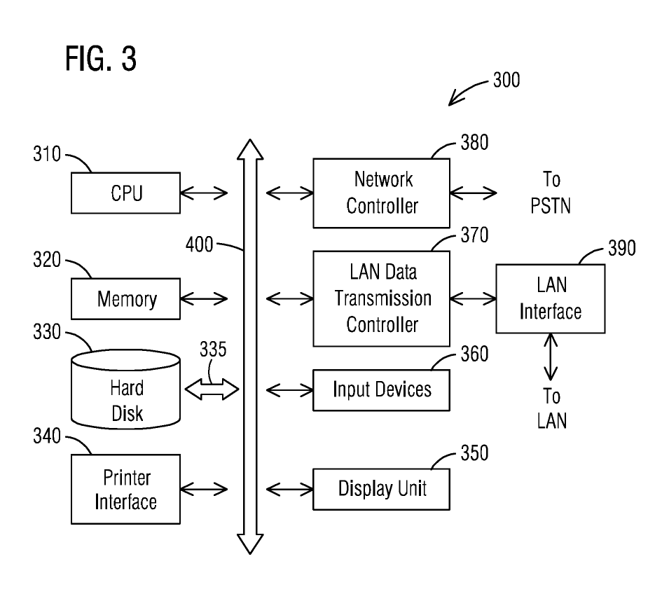

Industrial and engineering applications 190 as used herein include many different types of tools, programs and applications such as for example safety systems for overpressure protection, plant piping and equipment corrosion management, oil and gas facilities design and simulation, project planning tools to develop technical definitions and solutions, project management tools/software for planning, organizing and manage resource tools and develop resource estimates, and product lifecycle management applications. The industrial and engineering applications as used herein comprise software and include instructions executable on a computer system. An example of such a computer system is described in more detail with reference to FIG. 3.

Specific examples of industrial and engineering applications 190, which may utilize the UBR system 100 and method as disclosed herein, are the Oil and Gas Manager™ (OGM™) provided by Siemens. OGM™ is an industry standard project planning tool designed to develop complete technical solutions, as well as capital and operating cost estimates, for oil and gas development projects. Further examples of industrial and engineering applications 190, provided by Siemens, are Process Safety Pressure Protection Manager™ (PSPPM™), PS Asset Integrity Manager® (PSAIM™), UltraPIPE®, and PS Change Manager® (PSCM™). Process Safety Pressure Protection Manager™ (PSPPM™) is software for managing pressure relief system data to enable design, analysis and documentation of new and existing relief and disposal safety systems that provide overpressure protection in oil and gas, refining and chemical or other process industries. UltraPIPE® and PS Asset Integrity Manager® (PSAIM™) are applications for critical equipment corrosion monitoring and management, inspection planning and scheduling, and remaining life calculation of plant piping and equipment. PS Change Manager® (PSCM™) enables customers to implement an effective and consistent process to manage qualified changes and process safety risk in a plant.

It should be noted that the UBR system 100 and method as described herein are not limited to the above-mentioned examples of industrial and engineering applications 190, but can be implemented for many other software applications in different fields and areas such as for example accounting applications, sales managing applications or legal management applications etc.

As noted before, currently, a customer or user of an industrial or engineering application 190 does not have the ability or option to tailor usage of the application 190 on an intermittent basis, for example according an activity level for specific intermittent time durations of a project and/or engineering study, and pay for the application 190 when the application 190 is intermittently used and not have to pay when the application 190 is not used within the overall fixed and continuous time duration. What is available today is an intermittent usage to a fixed and continuous time duration ratio (R) of 1 (one) where a customer purchases one day, week, month or year of usage for a given instance of application license and has continuous use (in contrast to intermittent use based on their demand or activity level) within that time duration. Subsequently, the customer can re-purchase a license for continuous usage and/or enter into a new contract for the use of the license.

The UBR management system 100 and method as described herein provide flexibility both in terms of intermittent usage (and consequently payment) and overall fixed and continuous time duration/or an instance of the application 190.

With reference to FIG. 1, UBR management system 100 comprises application 190 and at least one UBR option 180. Typically, the system 100 comprises multiple UBR options 180. A UBR option 180 defines (intermittent) usage of the application 190 within an overall time frame.

A UBR option 180 comprises time segments or periods 110, 150. Time segment 110 includes “Total Term” (herein also referred to as total term 110 or fixed and continuous total term 110), and time segment 150 includes “Intermittent Permitted Usage in Term” (herein also referred to as intermittent permitted usage in term 150). Total term 110 comprises first point in time 120 and second point in time 130. First point in time 120 includes “Effective Date” (herein also referred to as effective date 120), and second point in time 130 includes “Term Expiry Date” (herein also referred to as term expiry date 130).

The total term 110 and the intermittent permitted usage in term 150 each comprises a time unit, i.e. they are measured in time. In an exemplary embodiment, the total term 110 and intermittent permitted usage in term 150 are measured in business days. Business day(s) as used herein are defined for example as work day(s) excluding Saturday and Sunday comprising a certain number of hours of work per day, for example 9 (nine) hours of work per day. It should be noted that the total term 110 and intermittent permitted usage in term 150 may be defined differently, for example in hours, days or months. Business days may comprise less or more than 9 hours and may include Saturday. Further, it should be noted that the total term 110 and intermittent permitted usage in term 150 may be measured in other units, such as for example monetary unit or another desired unit capable of measuring the total term 110 and intermittent permitted usage in term 150.

The total term 110 is defined as the number of business days, starting from the effective date 120 and ending at the term expiry date 130, in which the intermittent permitted usage in term 150 of the application 190 must be completed. The effective date 120 of the total term 110 is defined as the business day on which the application is operable by the customer or user. The term ‘operable’ is used herein means that the application is functional and usable, i.e. the application can be used by the customer. The term expiry date 130 is defined as the business day on which the total term 110 of the usage based renal of the application 190 will terminate.

The intermittent permitted usage in term 150 lies within total term 110, which means that the intermittent permitted usage in term 150 is smaller or less than the total term 110. The intermittent permitted usage in term 150 is defined as the maximum amount of intermittent usage of the application 190 during the total term 110 and comprises UBR expiry date 160 which is relative to the date when the user starts using the application 190 on the effective date 120. This means that the UBR expiry date 160 lies after the effective date 120 and the date the application 190 is used for the first time but prior to term expiry date 130. The UBR expiry date 160 further depends on how often or how much the application 190 is used during the total term 110.

In an example, the total term 110 may comprise 90 business days, and the intermittent permitted usage in term 150 is less than 90 business days, for example 60 calculated business days. As described before, the business days can be defined for example as work day(s) excluding Saturday and Sunday comprising 9 (nine) hours of work per day. For example, if the total term 110 starts on Sep. 4, 2017 (effective date 120), the term expiry date 130 would be Nov. 24, 2017 (counting 90 business days without Saturday and Sunday). This means that the concept of business days for the total term 110 corresponds to calendar days.

In contrast, with respect to intermittent permitted usage in term 150, the concept of business days is calculated business days. This means that the calculated business days are determined by actually counting increments (for example by permitted usage counter 140) at for example 5 (five) minute intervals and when the permitted usage counter 140 has reached 9 hours (since a business day is defined comprising 9 hours) a calculated business day of intermittent permitted usage in term 150 has occurred. This means that a calculated business day can occur over any time period, for example over 1 calendar day or over a time period of one month (a calculated business day is independent of a calendar day).

The UBR expiry date 160 of the intermitted permitted usage in term 150 is the date when the 60 calculated business days are completed, i.e. the application 190 has been used for those 60 calculated business days within the 90 business days of the total term 110 and prior to the term expiry date 130. If the 60 calculated business days of intermittent permitted usage in term 150 is not completed prior to term expiry date 130, then the UBR option 180 may lapse and require the customer/user to start a new UBR option 180.

A software application, in our example the industrial or engineering application 190, is typically distributed via a license, wherein licensor (the software provider) and licensee (the customer or user) enter a license agreement. The effective date 120 can be the business day on which the software license agreement has been fully executed. The effective date 120 may be a different date than the day the agreement has been executed, for example a date that the licensor and licensee agree that the combination of intermittent permitted usage in term 150 and total term 110 should begin.

The term “rental” as used herein applies to rental (non-recurring license term) and subscription (recurring license term) and to perpetual license (indefinite license term for a specific product version).

In an exemplary embodiment, parameters 170 of the UBR options 180 and for usage management of the application 190 can be defined and stored within the management system 100. The parameters 170 can be defined and stored in a separate file, for example a license file using a specific software tool. The parameters 170 may be stored within the application 190. The parameters 170 include at least the effective date 120, ratio R, intermittent permitted usage in term 150 and term expiry date 130. The parameters 170 can be for example number of hours (amounting to the calculated business days) of intermittent permitted usage in term 150 (in effect the intermittent usage), and the term expiry date 130, wherein the term expiry date 130 can be manually calculated based on a predefined total term 110 (in effect the overall fixed and continuous time duration) in business days and the effective date 120 defined as the date the license is issued.

The UBR management system 100 provides management of the intermittent permitted usage in term 150 within the total term 110 for the application 190 based on a predefined intermittent usage to overall fixed and continuous time duration ratio R. The usage to time duration ratio R is defined as R=P/T, wherein P is the intermittent permitted usage in term 150, and T is the fixed and continuous total term 110. As noted before, both P and T are measured in time, for example in (calculated) business days. According to our example described before comprising 90 business days (corresponding to calendar days without Saturday and Sunday) of total term 110 and 60 calculated business days of intermittent permitted usage in term 150, the ratio R equals 0.66. In another exemplary embodiment of the present disclosure, the ratio R is 0.5 (½). This means that the total term 110 comprises two times the amount of business days of the intermitted permitted usage in term 150. However, the ratio R can be tailored per the demands to another ratio R between 0 (zero) and 1 (one), for example R=0.25 or R=0.75 or R=0.66 (see our example above) etc.

For example, based on an intermittent usage to overall fixed and continuous time duration ratio R of 0.5, parameters 170 may be set as follows and provide the following UBR options 180:
UBR 30-60: 30 calculated business days of intermittent permitted usage in term 150 during 60 business days of total term 110;
UBR 60-120: 60 calculated business days of intermittent permitted usage in term 150 during 120 business days of total term 110;
UBR 90-180: 90 calculated business days of intermittent permitted usage in term 150 during 180 business days of total term 110.

According to an embodiment of the present disclosure, starting on the effective date 120, the application 190, running on the computer system, is configured to monitor the intermittent permitted usage in term 150 and to increment a permitted usage counter 140 while the application 190 is open and the computer system in active mode assuming the user is actively utilizing the application 190. When the computer system is in stand-by or in hibernation mode, the permitted usage counter 140 is paused. In an example, the application 190 increments the permitted usage counter 140 every 5 minutes. It should be noted that the permitted usage counter 140 can be incremented in any desired period, for example every minute (one minute) or every ten (10) minutes.

According to another embodiment of the present disclosure, the application 190 is configured to monitor the permitted usage counter 140 and to issue a warning message to the application user when the permitted usage counter 140 exceeds a predefined amount (for example in percentage) of the intermittent permitted usage in term 150, for example when the permitted usage counter 140 exceeds 90% of the intermittent permitted usage in term 150. The intermittent permitted usage in term 150 can be converted from business days to hours for comparison checks. When the permitted usage counter 140 equals the intermittent permitted usage in term 150, the application 190 is configured such that a warning message is issued to the user to save the data in the application 190 and that the application 190 will close after a certain amount of time, for example after 5 (five) minutes, if the user does not actively close the application 190. If the permitted usage counter 140 exceeds the intermittent permitted usage in term 150 during usage of the application 190, the application 190 will close. However, if the user opens the application 190 after the intermittent permitted usage in term 150 has been exceeded or the term expiry date 130 has been exceeded, the application 190 will not allow usage.

The application 190 is further configured to monitor the date of use relative to the term expiry date 130 and is configured to issue a further warning message indicating for example that the current date is less than 14 (fourteen) days from the term expiry date 130. If the current date exceeds the term expiry date 130, the application 190 will require the user to obtain a new intermittent permitted usage in term 150, for example to upload a new (license) file with a corresponding and valid term expiry date 130 before opening and starting the application 190 again.

FIG. 2 illustrates a flow chart of a method 200 for providing UBR of an industrial or engineering application 190 in accordance with an exemplary embodiment of the present disclosure. The method 200 utilizes the UBR management system 100 as described with reference to FIG. 1.

The method 200 comprises providing an application 190 comprising instructions executable on a computer system comprising at least one processor (step 210). Multiple UBR options 180 are created, wherein a UBR option 180 defines (intermittent) usage of the application 190 within an overall time frame (step 220). One of the multiple UBR options 180 is selected, wherein the application 190 is then usable according to the selected UBR option 180.

In a specific example, a customer or user is interested in obtaining a license for the application 190. Further, the customer/user wants to use the application 190 on an intermittent basis and only pay for the application 190 when the application 190 is truly used. Thus, the application provider (licensor) offers multiple UBR options 180 to the customer. The customer chooses an UBR option 180 as described before, for example ‘UBR 30-60’ which means that the application 190 can be intermittently used for 30 (calculated) business days within a total term of 60 business days. The option 180 is selected (step 230), and the application 190 is usable according to the selected option 180.

The method 200 further comprises monitoring the UBR option 180, specifically the intermittent usage to fixed and continuous time duration ratio R utilizing permitted usage counter 140 (step 240). A warning message is issued to the customer, when the permitted usage counter 140 exceeds for example 90 (ninety) % of the intermittent permitted usage in term.

In our example described before comprising 90 business days (corresponding to calendar days without Saturday and Sunday) of total term 110 and 60 (calculated) business days of intermittent permitted usage in term 150, when the permitted usage counter 140 exceeds 90% of the 60 calculated business days, which is 54 calculated business days, a warning message is issued to the customer which may read as follows: “Please note that 486 hours (corresponding to 54 calculated business days) of the application have been used. 54 hours (corresponding to 6 calculated business days) are left before the application terminates”. As noted before, the 54 calculated business days are calculated based on minutes when the application was used and therefore is not a date in time which is 54 business days after the effective date 120 of the total term 110. When the intermittent permitted usage in term 150 has been fully utilized, the application will be closed/terminated, and the customer cannot use the application 190 any longer (step 250). In this scenario, it is possible that only the intermittent permitted usage in term 150 has been exceeded whilst the total term 110 has not and if the user/customer tries to subsequently use the application 190, it will not open and may provide a message reading: “The permitted days of usage have been consumed. Please procure a new license”.

The method 200 further comprises monitoring a date of use relative to the term expiry date 130 of the total term 110, wherein a message is issued when the date of use exceeds the term expiry date. For example, a message to the customer may read as follows: “Please note that the application cannot be used because the total term of use of the application has expired”. When the total term 110 has expired, the application 190 will be closed/terminated, and the customer cannot use the application 190 any longer (step 250). In this scenario, it is possible that the intermittent permitted usage in term 150 has not been exceeded whilst the total term 110 has been exceeded and so if the user/customer tries to subsequently use the application 190, it will not open and may provide a message reading: “The total term for usage has been consumed. Please procure a new license”.

The described UBR management system 100 and method 200 can be configured such that the customer/user, after executing an agreement with the application provider, downloads and stores the application 190 on a computer system of the customer, i.e. the application 190 is hosted and stored by the customer. In another configuration, the application 190 can be hosted and stored by the application provider, and the customer can then access and use the application. In an example, the application provider utilizes cloud storage, wherein the application 190 is stored for example on a server owned and managed by the application provider, and the customer accesses and uses the application for example via a cloud storage gateway. Thus, the customer does not need to store the application 190 and saves storage space and resources for managing the application 190.

Summarizing, the disclosed UBR management system 100 and method 200 provides flexibility in tailoring intermittent usage with in an overall fixed and continuous time duration to ratio R between 0 (zero) and 1 (one). Instead of paying for a series of one-month terms of unlimited use which may include time the application 190 is not being used even though the time is being paid for, the management system 100 and method 200 allow the customer to pay for only the time they use the application 190. Continuous usage restriction, which arises from current known methods of purchasing multiple application licenses during the total term, is eliminated. Redundant procurement cycles are eliminated or reduced, which means that procurement time and cost are reduced for both the customer (licensee) and application provider (licensor).

FIG. 3 shows an example of a computer system 300 which may implement a method 200 and system 100 of the present disclosure. The system 100 and method 200 of the present disclosure may be implemented in the form of a software application running on computer system 300, for example, a mainframe, personal computer (PC), handheld computer, server, etc. The software application may be stored on a recording media locally accessible by the computer system 300 and accessible via a hard wired or wireless connection to a network, for example, a local area network, or the Internet.

The computer system 300, referred to generally as system 300, may include, for example, a central processing unit (CPU) 310, random access memory (RAM) 320, a printer interface 340, a display unit 350, a local area network (LAN) data transmission controller 370 (for wired or wireless data transmission), a LAN interface 390, a network controller 380, an internal bus 400, and one or more input devices 360, for example, a keyboard, mouse etc. As shown, the system 300 may be connected to a data storage device 330, for example a hard disk, via a link 335.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

1. A method for providing usage based rental (UBR) of an industrial or engineering application comprising:
providing an application comprising instructions executable on a computer system comprising at least one processor;
providing a plurality of usage based rental (UBR) options for the application, each usage based rental (UBR) option comprising an intermittent usage to a fixed and continuous time duration ratio R between 0 (zero) and one (1); and
selecting a usage based rental (UBR) option from the plurality of usage based rental (UBR) options, wherein the application is operable according to the selected ratio R governing the usage based rental (UBR) option.

2. The method of claim 1, wherein the usage to time duration ratio R is defined as R=P/T, wherein
P is an intermittent permitted usage in term, and
T is a fixed and continuous total term.

3. The method of claim 1, wherein the usage to time duration ratio R is 0.5 (½).

4. The method of claim 2, wherein the fixed and continuous total term is defined as business day(s) corresponding to calendar days without Saturday and Sunday, each business day comprising 9 (nine) hours.

5. The method of claim 2, wherein the intermittent permitted usage in term is defined as calculated business day(s), each calculated business day comprising 9 (nine) hours, wherein one calculated business day has occurred when the application was intermittently used for 9 hours over an arbitrary time period.

6. The method of claim 1, further comprising:
monitoring the intermittent usage to fixed and continuous time duration ratio R utilizing a permitted usage counter; and
issuing a warning message when the usage counter exceeds 90 (ninety) % of the intermittent permitted usage in term P.

7. The method of claim 1, further comprising:
monitoring a date of use relative to a term expiry date of the total term;
issuing a message when the date of use exceeds the term expiry date.

8. The method of claim 2, further comprising:
terminating the application when the intermittent permitted usage in term is expired or when the total term is expired.

9. The method of claim 1, wherein the application comprises instructions for safety systems for overpressure protection, plant piping and equipment corrosion management, or oil and gas facilities design and simulation.

10. A usage based rental (UBR) management system comprising:
an application comprising instructions executable on a computer system comprising at least one processor;
a plurality of usage based rental (UBR) options for the application, each usage based rental (UBR) option comprising an intermittent usage to a fixed and continuous time duration ratio R, wherein the intermittent usage to fixed and continuous time duration ratio R comprises a total term and an intermittent permitted usage in term; and
a permitted usage counter for monitoring the intermittent permitted usage in term.

11. The UBR management system of claim 10, wherein the total term is greater than the intermittent permitted usage in term.

12. The UBR management system of claim 10, wherein the intermittent usage to fixed and continuous time duration ratio R is 0.5 (one half), wherein a unit of measurement is business days.

13. The UBR management system of claim 12, wherein the intermittent permitted usage in term is measured in calculated business days and the total term is measured in business days based on calendar days.

14. The UBR management system of claim 9, wherein the application is configured to monitor the intermittent usage to fixed and continuous time duration ratio R utilizing the permitted usage counter and to increment the permitted usage counter when the application is in use.

15. The UBR management system of claim 14, wherein the application is configured to issue a warning message when the permitted usage counter exceeds 90 (ninety) % of the intermittent permitted usage in term.

16. The UBR management system of claim 10, wherein the application is configured to
monitor a date of use relative to a term expiry date of the total term, and
issue a message when the date of use exceeds the term expiry date.

17. The UBR management system of claim 10, wherein the application is configured to terminate the application when the intermittent permitted usage in term is expired or when the total term is expired.

18. A computer system comprising:
at least one processor; and
a usage based rental (UBR) management system as claimed in claims 10-17.
